(19) United States
(12) Patent Application Publication
(10) Pub. No.: US 2012/0144380 A1
(43) Pub. Date: Jun. 7, 2012

(54) METHOD FOR GENERATING DELTA FILE USING BASIC BLOCKS

(75) Inventors: Bryan Eugene Rabeler, Keller, TX (US); BalaSubrahmanyam Gattu, Garland, TX (US); Tao Xue, Plano, TX (US)

(73) Assignee: SAMSUNG ELECTRONICS CO. LTD., Suwon-si (KR)

(21) Appl. No.: 13/295,305

(22) Filed: Nov. 14, 2011

Related U.S. Application Data
(60) Provisional application No. 61/420,661, filed on Dec. 7, 2010.

(51) Int. Cl. G06F 9/44

(52) U.S. Cl. 717/170

(57) ABSTRACT

An apparatus and method for generating a delta file reflecting changes between a prior version of a firmware and a new version of the firmware are provided. The method includes disassembling a binary file of the prior version and a binary file of the new version, identifying old basic blocks in the disassembled prior version, identifying new basic blocks in the disassembled new version, matching the new basic blocks with the old basic blocks, simulating an operation of an updater of a mobile terminal based on results of the matching, identifying differences between the simulation result and the new version, and generating the delta file based on the results of the matching and the identified differences between the simulation result and the new version.

### CROSS-REFERENCE TO RELATED APPLICATIONS

This application claims the benefit under 35 U.S.C. §119(e) of a U.S. Provisional application filed on Dec. 7, 2010 in the U.S. Patent and Trademark Office and assigned Ser. No. 61/420,661, the entire disclosure of which is hereby incorporated by reference.

### BACKGROUND OF THE INVENTION

1. Field of the Invention

The present invention relates to an apparatus and method for generating delta files. More particularly, the present invention relates to an apparatus and method for generating delta files through a comparison of executable programs using basic blogs and weighted instruction components.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

Typically, a mobile terminal manufacturer prepares the mobile terminal with the necessary firmware to operate the mobile terminal and provides the mobile terminal to carriers for sale to users. To generate the firmware, the mobile terminal manufacturer often employs a linker offered by the manufacturer of the microprocessor controlling the mobile terminal. The linker collects the object code for the program and links them together into a runnable image that can be stored in the memory of the mobile terminal.

The mobile terminal manufacturer also makes firmware updates available to the users. An update may be necessary to correct bugs, to enhance security, or provide additional features. The updates are typically provided to the users via a delta file. The delta file includes the new or updated code and data in the firmware update, as well as instructions to permit the mobile terminal to update the previously stored firmware. To reduce size, the delta file generally does not include code or data that has not changed in the updated firmware.

However, in order to generate the delta file, the old firmware and the updated firmware need to be compared so that the differences can be identified. This process can be slow and time-consuming. As a result, the schedule for the release of the firmware update to users may be delayed. Accordingly, there is a need for an apparatus and method for providing improved differencing of firmware code and data.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for comparing executable programs to generate a delta file.

In accordance with an aspect of the present invention, a method for generating a delta file reflecting changes between a prior version of a firmware and a new version of the firmware is provided. The method includes disassembling a binary file of the prior version and a binary file of the new version, identifying old basic blocks in the disassembled prior version, identifying new basic blocks in the disassembled new version, matching the new basic blocks with the old basic blocks, simulating an operation of an updater of a mobile terminal based on results of the matching, identifying differences between the simulation result and the new version, and generating the delta file based on the results of the matching and the identified differences between the simulation result and the new version.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram of a mobile terminal according to an exemplary embodiment of the present invention;

FIG. 2 is a flowchart of a method for generating a delta file according to an exemplary embodiment of the present invention; and

FIG. 3 is a flowchart of a method of comparing basic blocks according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following exemplary embodiments of the present invention are described as applied to a “mobile terminal.” However, it is to be understood that this is merely a generic term and that the invention is equally applicable to any of a mobile phone, a palm sized Personal Computer (PC), a Personal Digital Assistant (PDA), a Hand-held PC (HPC), a smart phone, an International Mobile Telecommunication 2000 (IMT-2000) terminal, a wireless Local Area Network (LAN) terminal, and the like. Accordingly, use of the term “mobile terminal” should not be used to limit application of the present inventive concepts to any certain type of apparatus or device.

Although the exemplary embodiments of the present invention provided herein are described with reference to a mobile terminal, the exemplary embodiments are not limited thereto. Exemplary embodiments of the present invention may be applied to any device having firmware updateable via a delta file. For example, many home appliances may be equipped with a firmware and wired or wireless interface, such that the home appliance could receive a delta file to update the firmware to correct bugs or apply new features. Delta files created according to exemplary embodiments of the present invention may also be applied to these home appliances, or to any device having firmware updateable by a delta file.

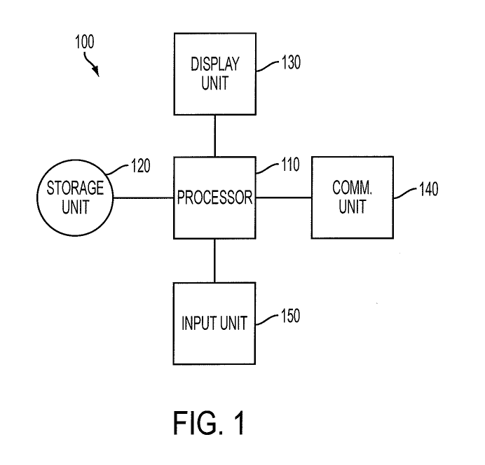

FIG. 1 is a diagram of a mobile terminal according to an exemplary embodiment of the present invention.

Referring to FIG. 1, a mobile terminal 100 according to an exemplary embodiment of the present invention includes a processor 110, a storage unit 120, a display unit 130, a communication unit 140, and an input unit 150. According to exemplary embodiments of the present invention, the mobile terminal 100 may include additional and/or different units. Similarly, the functionality of two or more units may be integrated into a single component.

The processor 110 controls the overall operations of the mobile terminal 100 using firmware (not shown) stored in the storage unit 120. According to an exemplary embodiment of the present invention, the processor 110 may support the ARM architecture developed and licensed by ARM Holdings, Inc. The processor 110 executes an updater to update the firmware based on a delta file received from a manufacturer of the mobile terminal 100 or a manufacturer of the firmware. When a delta file is received via the communication unit 140, the updater executes instructions contained in the delta file to add, copy, or replace portions of the existing firmware to correspond to the updated (new) version.

The storage unit 120 stores various files and other data in the mobile terminal. The storage unit may be understood as including several types of storages, such as a Random Access Memory (RAM) for storing user data, and storage for storing program data such as the firmware. The section for storage data may be flash memory, Read Only Memory (ROM), and the like.

The display unit 130 displays information to the user of the mobile terminal. The display unit 130 may be provided as a Liquid Crystal Display (LCD). In this case, the display unit 130 may include a controller for controlling the LCD, a video memory in which image data is stored and an LCD element. If the LCD is provided as a touch screen, the display unit 130 may perform a part or all of the functions of the input unit 150.

The communication unit 140 is configured to include a Radio Frequency (RF) transmitter (not shown) for up-converting the frequency of transmitted signals and amplifying the transmitted signals, and an RF receiver (not shown) for low-noise amplifying of received RF signals and down-converting the frequency of the received RF signals. The communication unit 140 may also include a wired interface, such as Ethernet and/or Universal Serial Bus (USB).

The input unit 150 receives input from the user. The input unit 150 may be configured as a component of the display unit 130, as described above. The input unit 150 may also be configured as a keypad or a plurality of keys to receive input from the user.

When the firmware stored in the storage unit 120 is to be updated, a delta file is transmitted to the mobile terminal This process is known as Firmware Over The Air (FOTA). The delta file is typically obtained from a delta generator, which performs a binary comparison of the original firmware with the updated firmware. However, this process is time-consuming.

The delta generator compares binary images (e.g., a binary image of the original and updated firmware) and prepares a set of delta instructions to cause the processor 110 to update the firmware in the storage unit 120 to the new version. The delta generator typically performs its operations in a purely binary manner on the code itself as a whole. This typical process has several disadvantages. First, a small change to the code of the firmware may result in cascading secondary changes due to reference changes in the rest of the firmware caused by the initial, small change. Second, the small change could cause a compiler to optimize the code differently, such as by reordering a small section of the code or by allocating registers differently. The typical delta generator creates a delta file that takes all of these changes into account. The resulting delta file may be quite large, even though the code that has actually changed is quite small.

To address this issue, according to an exemplary embodiment of the present invention, the executable code is divided into basic blocks. Global symbols are used to identify groups of basic blocks in the old and new versions to be matched up. Basic blocks in a particular group in the new version are matched against basic blocks of the same group in the old version. The basic blocks in one group of the new version do not need to be matched with basic blocks in another group of the old version. The basic blocks in the other groups of the old version are associated with different global symbols, and so it is highly unlikely that a basic block in one group of the new version will have a better match with a basic block in a different group of the old version. The result of this comparison is used to identify the differences between corresponding basic blocks and to generate the delta file.

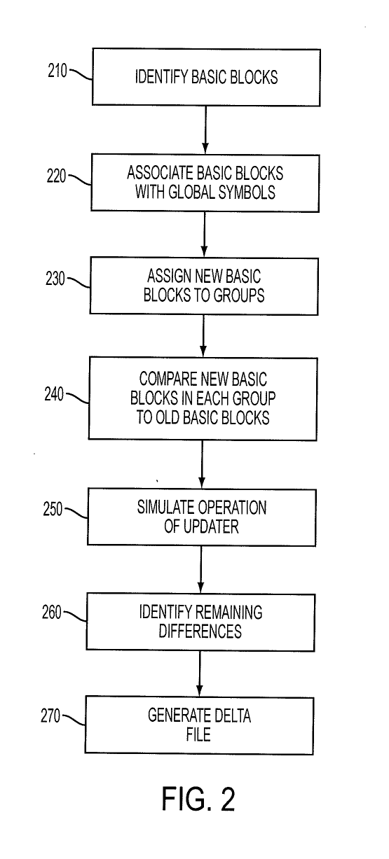

FIG. 2 is a flowchart of a method for generating a delta file according to an exemplary embodiment of the present invention.

Referring to FIG. 2, a linker creates an Executable and Linkable Format (ELF) file containing binary images of both a new and old version of firmware to be transmitted to a mobile device for updating. In step 210, the delta generator disassembles the new and old versions into a two sets of basic blocks. One set includes the basic blocks of the old version (old basic blocks), and the other set includes the basic blocks of the new version (new basic blocks). A basic block is a sequence of assembly instructions that has one entry point and one exit point. When the first line (entry point) of a basic block is executed, each of the remaining lines will also be executed, in order, until reaching the last line (exit point). In any basic block, each of the lines after the first will only execute after all of the previous lines in the basic block have executed.

In step 220, the old and new basic blocks are associated with global symbols. A basic block is associated with a global symbol if the basic block is reachable from code at the global symbol through a sequence of local references. For example, if a basic block B1 starts at the address of a global symbol G1, then the basic block B1 is associated with the global symbol G1. Similarly, if a basic block B2 is called via a local reference by B1, then the basic block B2 is also associated with the global symbol G1, because B2 can be reached from G1 by the local reference in B1. The global symbol information may be obtained from the ELF file output by the linker.

In step 230, the new basic blocks are assigned to groups. Every new basic block in a group is connected to another new basic block in the group by one or more local references. For example, if the new basic block B1 is associated with the global symbol G1, the new basic block B2 is associated with global symbols G1 and G2, and a new basic block B3 is associated with global symbols G1, G2, and G3, then the new basic blocks B1, B2, and B3 will be placed in the same group due to their association with the global symbol G1. New basic blocks that are not associated with any global symbols are placed in their own default group.

In step 240, the new basic blocks in each group are compared with old basic blocks. The old basic blocks are selected for comparison based on their type and the global symbols they are associated with. For example, if a new basic block B1 is associated with global symbols G1 and G2, the new basic block B1 will be compared against an old basic block O1 that is also associated with the global symbols G1 and G2. New basic blocks that are in the default group (i.e., those basic blocks that are not associated with any global symbols) are compared with old basic blocks that are also not associated with any global symbols.

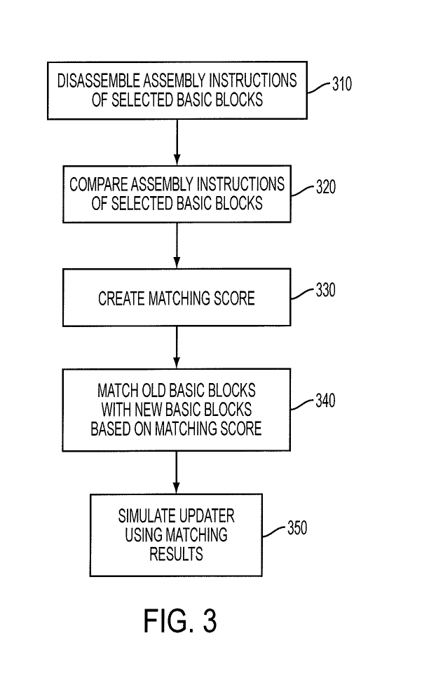

Since global symbols are unlikely to change between the old and the new versions, the number of new basic blocks that are compared with old basic blocks is reduced. Global symbols represent strings that are unlikely to change between the old and new versions. As a result, basic blocks associated with a given global symbol in the old version are likely to remain associated with that global symbol in the new version. Basic blocks associated with the same global symbol are therefore more likely to match. As the result, the number of basic blocks needing to be compared may be reduced by only comparing basic blocks associated with the same global symbol. This operation is described in more detail below with respect to FIG. 3.

In step 250, the delta generator simulates the operation of the updater in the mobile terminal 100. The simulation includes applying a series of COPY instructions to a collection of flash blocks corresponding to the old version based on the matching basic blocks. The COPY instructions connect address locations of the basic blocks from the old version with corresponding address locations of the basic blocks in the new version. When each COPY instruction is applied to a basic block in the simulation, address references originating from the basic block in the old version are replaced with corresponding references from the matching basic block in the new version. Basic blocks that have not changed (i.e., that are the same between the old version and the new version) are not affected. The result of the simulation is a collection of flash blocks, each block having content similar to what a real flash block would have on the mobile terminal 100 after the update process.

In step 260, the delta generator compares the results of the simulation with the new version to identify any remaining differences between the two. This includes a comparison of the flash blocks obtained from the simulation with the flash blocks in the new version. The delta generator may employ any technique to identify these remaining differences.

In step 270, the delta generator generates a delta file based on the results of the matching and the remaining differences identified in step 260. The delta file may be provided to the mobile terminal 100 via FOTA to enable the processor 110 to update the firmware stored in the storage unit 120. The new version may have a basic block which does not exist in the old version, or a basic block which is not a good match for a basic block in the old version. In these situations, the entire contents of the new basic block will be included in the delta file, along with an ADD instruction to create the new basic block.

FIG. 3 is a flowchart of a method of comparing basic blocks according to an exemplary embodiment of the present invention.

Referring to FIG. 3, the delta generator selects two basic blocks to compare, one old basic block and one new basic block. As described above, the two basic blocks are each associated with the same global symbols. Basic blocks which are associated with the same global symbols are more likely to correspond to each other than basic blocks that are not associated with the same global symbols; limiting the comparison enables the delta generator to process the basic blocks faster.

The delta generator may take several factors into account when determining the order in which basic blocks are selected for comparison. These factors include the number of possible matches and the number of references originating from the new basic block. For example, the delta generator may select a new basic block having fewer possible matches before a new basic block having many possible matches. Similarly, the delta generator may select new basic blocks having relatively few originating references over new basic blocks having many originating references. For the sake of convenience, the old and new basic blocks being compared are assumed to have the same number of lines. However, according to exemplary embodiments of the present invention, the delta generator may also compare basic blocks having a different number of lines.

In step 310, the delta generator disassembles each line of the selected old and new basic blocks into their corresponding elements. Each line includes an assembly instruction, and the assembly instruction in turn includes one opcode and zero or more arguments. The opcode specifies the action to be taken by the processor. The arguments may be a register, a constant value, or a reference.

In step 320, the delta generator compares corresponding assembly instructions and generates a score for the assembly instruction based on the results of the comparison. The delta generator applies different weights to different components of the assembly instructions. The delta generator will give greater weight to the opcode component than to the arguments. In contrast with the arguments, assembly instructions having different opcodes will represent two different instructions. Instructions with different opcodes perform two different operations. As a result, instructions with different opcodes will generally have different arguments and different encodings for those arguments. The instructions are likely to differ greatly; most likely, every byte of the instructions will be different, and there will be no correlation at all between the two instructions.

Arguments, on the other hand, are not generally given as great a weight as opcodes, for several reasons. Firstly, if an argument in the old version has an immediate value of 1, while the argument in the new version has an immediate value of 0, the actual difference between the two lines is small (e.g., one bit). A similar observation holds with respect to different registers. Secondly, the same instruction may have different arguments depending on how the assembler allocated registers. For example, when the old version was assembled, the assembler might have allocated the register r0 to a particular argument. In assembling the new version, however, the assembler may have allocated the register r1 to the same argument. As a result, the two instructions are the same, but will appear to have different arguments. Since the value of the arguments does not have as great an impact on the comparison, the delta generator assigns lower weights to the arguments than to the opcodes.

In step 330, the delta generator creates a composite matching score representing a degree of similarity (or dissimilarity) between the selected new basic block and the selected old basic block. The composite score is the sum of the scores for each of the assembly instructions. If the old basic block of the old version has a high score with respect to the new basic block of the new version, the two basic blocks are more likely to be a match.

The delta generator repeats steps 310, 320, and 330 for each new and old basic block to be compared. For example, if a group contains new basic blocks B1, B2, and B3, to be compared in that order, and the possible matches for this group include old basic blocks O1, O2, O3, and O4 of the old version, the delta generator will perform steps 310, 320, and 330 starting with basic blocks B1 and P1, and then repeat the steps for basic blocks B1 and O2, and so on until the new basic block B1 has been compared with each of the old basic blocks O1-O4. The delta generator will then perform the steps 310-330 in a similar fashion for new basic block B2. In this example, when the process is complete, each of the new basic blocks B1, B2, and B3 will have four sets of matching scores, one for each of the old basic blocks O1, O2, O3, and O4.

In step 340, the delta generator identifies matches between new basic blocks and old basic blocks, based on the scores created in step 330. For each new basic block, the delta generator discards old basic blocks which have a score below a certain threshold. Scores below this threshold indicate that the old basic block corresponding to that score are not likely to be a match with the new basic block.

The remaining old basic blocks are all considered as possible matches for the corresponding new basic block. For each of these possible matches, the delta generator maintains two lists of references. The first list includes references originating from the new basic block. The second list includes references targeting the new basic block. These lists are used to generate a confidence number.

The delta generator assigns each possible match a confidence number indicating the likelihood that the possible match is a final match. A high confidence score indicates a high probability that the possible match is a final match. The delta generator calculates the confidence score based on the matching score between a new basic block and an old basic block and a status of the references contained in the new basic block. The references contained in the new basic block include references originating from the new basic block and references which target the new basic block. The status of the references indicates whether each reference is patchable or not patchable.

At the outset, all of the matches will be possible matches, and the confidence score will be reduced to reflect this situation. The reduction of the confidence score by possible matches indicates the risk in selecting a wrong match. If the wrong match is selected, references targeting the incorrectly matched new basic block may be patched incorrectly. This could result in the reference being patched incorrectly. In this case, additional instructions will need to be generated in the delta file to fix the incorrect patch. This will increase the size of the delta file unnecessarily, as the additional instructions would not have been generated if the new basic block were matched correctly. Accordingly, a possible match for a new basic block having many references is more risky than a possible match for a new basic block with few or no references. Since the confidence score is reduced by the number of possible references, the delta generator is more likely to select new basic blocks having a small number of references at first, because the confidence score of these new basic blocks will not be reduced by as much.

For each new basic block in a group, a possible matching old basic block having the highest confidence number is selected as a final match. The confidence score of the basic blocks may be adjusted to reflect the selection of a final match. As new basic blocks are matched with old basic blocks, the delta generator creates a COPY instruction based on the match result, which connects the address location of the old basic block with the address location of the new basic block. The delta generator uses the final matches when simulating the operation of the updater in step 350 of FIG. 3.

According to exemplary embodiments of the present invention, a new version of the firmware is analyzed according to its structure, not according to the code as a whole. This more refined analysis enables a delta generator to identify minor changes easily, and results in a reduced delta file size. Accordingly, the update process for a mobile terminal may occur more smoothly and quickly due to a reduced file download time and reduced updating time.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for generating a delta file reflecting changes between a prior version of a firmware and a new version of the firmware, the method comprising:
disassembling a binary file of the prior version and a binary file of the new version;
identifying old basic blocks in the disassembled prior version;
identifying new basic blocks in the disassembled new version;
matching the new basic blocks with the old basic blocks;
simulating an operation of an updater of a mobile terminal based on results of the matching;
identifying differences between the simulation result and the new version; and
generating the delta file based on the results of the matching and the identified differences between the simulation result and the new version.

2. The method of claim 1, wherein the matching of the new basic blocks with the old basic blocks comprises:
associating the old basic blocks with at least one global symbol;
associating the new basic blocks with at least one global symbol;
assigning the old basic blocks into groups;
assigning the new basic blocks into groups; and
for each group, comparing the new basic blocks of the group with the old basic blocks.

3. The method of claim 2, wherein the assigning of the groups comprises:
assigning the new basic blocks into the groups such that each new basic block in a group is connected to another new basic block in the group by one or more local references.

4. The method of claim 2, wherein the comparing of the new basic blocks of the group with the old basic blocks comprises:
for each group, comparing the new basic blocks of the group with old basic blocks that are associated with the same global symbols as those of the new basic blocks of the group.

5. The method of claim 2, wherein the comparing of the new basic blocks of the group with the old basic blocks comprises:
selecting one of the new basic blocks and one of the old basic blocks;
disassembling corresponding assembly instructions in the selected new and old basic blocks into components;
comparing the corresponding components of the corresponding assembly instructions;
generating a matching score for the selected new and old basic blocks based on results of the comparison; and
matching a new basic block with an old basic block based on the matching score.

6. The method of claim 5, wherein the selecting of one of the new basic blocks and one of the old basic blocks comprises:
selecting the one of the new basic blocks and the one of the old basic blocks based on at least one of a number of possible matches for the new basic block and a number of references originating from the new basic block.

7. The method of claim 5, wherein the comparing of the corresponding components comprises:
comparing the corresponding components of the corresponding assembly instructions based on weights assigned to each component.

8. The method of claim 7, wherein an opcode of the corresponding assembly instructions are assigned a greater weight than arguments of the corresponding assembly instructions.

9. The method of claim 5, wherein the matching of the new basic block with the old basic block based on the matching score comprises:
for each new basic block, identifying possible matching old basic blocks;
generating a confidence score for each possible match; and
selecting an old basic block as a final match with a corresponding new basic block based on the confidence score.

10. The method of claim 9, wherein the generating of the confidence score comprises:
generating the confidence score for each possible match based on the matching score and a status of references associated with the corresponding new basic block.

11. The method of claim 1, wherein the simulating of the updater comprises:
simulating an operation of an updater updating a firmware corresponding to the prior version stored on a device, the simulation including applying changes to a collection of flash blocks corresponding to the old version based on the results of the matching.

12. The method of claim 11, wherein the identifying of the differences comprises:
identifying differences between the flash blocks generated from the simulation and flash blocks of the new version.

13. The method of claim 12, wherein the generating of the delta file comprises:
generating the delta file based on the matching results and the identified differences between the flash blocks generated from the simulation and flash blocks of the new version.
